(19) United States
(12) Patent Application Publication
(10) Pub. No.: US 2003/0128845 A1
(43) Pub. Date: Jul. 10, 2003

(54) Method of scrambling a signal

(76) Inventor: Panos Kudumakis, London (GB)

Correspondence Address: Martin Fleit, Fleit Kain Gibbons Gutman & Bongini, 601 Brickell Key Drive # 404, Miami, FL, 33131, US

(21) Appl. No.: 10/181,466

(22) PCT Filed: Jan. 22, 2001
(86) PCT No.: PCT/GB01/00207

(30) Foreign Application Priority Data
Jan. 21, 2000 (GB) 0001286.4

(51) Int. Cl. H04N 7/167

(52) U.S. Cl. 380/210

(57) ABSTRACT

A method of scrambling a compressed audio and/or picture signal to provide a scrambled signal for distribution, the information content being recoverable from the scrambled signal using descrambling means (10) under the control of authorized recipients of the scrambled signal, is described. The method consists of or includes: a) encoding the information content using a wavelet filterbank having a tree structure, b) distributing the scrambled signal to authorized recipients, and c) decoding the information content using the corresponding inverse wavelet filterbank. The wavelet filter used, the wavelet filterbank tree structure, the number of decomposition stages in the tree structure and/or the time for which a given filter or tree structure or number of decomposition stages is used can be chanced in an apparently random fashion to improve security whilst keeping the scrambled signal recognizable. Progressively increasing distortion with time is also described.

This invention relates to a method of scrambling or encrypting the information content of a signal to provide a scrambled signal for distribution, the information content being recoverable from the scrambled signal using descrambling means tinder the control of authorised recipients of the scrambled signal.

There are two main methods of scrambling or encrypting signals. One method is to use symmetric cryptographic algorithmic such as the Data Encryption Standard (DES). These algorithms are independent of the syntax of the information they are protecting. Therefore access to the information, for example to recognise general features, is only possible if the decryption key is used.

Other methods of scrambling signals (such as audio or picture signals) are known. These algorithms are content sensitive. This gives the advantage that even if the descrambling key is not available access to a distorted version of the information content of the message is possible. This gives the content provider the opportunity, for example, to implement a “pre-listen” feature for audio signals. It is even possible for the content provider to choose the level of distortion or degradation heard by a party not using the correct descrambling key. Using this second method, there is an implication that each source coding algorithm (e.g. MP3, AAC or AC-3) will require a separate scrambling method. This can increase the security because attacking the scrambled bit-stream signal requires profound knowledge of the source code algorithm itself. An advantage of these bit stream scramblers is the very low computational complexity for scrambling, descrambling, and trans-scrambling (i.e. changing scrambling formats).

One particular technique for scrambling audio for MP3 and AAC formats has been developed by the Fraunhofer Institut Integrierte Schaltungen, Am Weichselgarten 3, D-91058 Erlangen, Germany, and is known as the “Compatible scrambling of compressed audio”. This system is described in Proc. 1999 IEEE Workshop on Applications of Signal Processing to Audio & Acoustics, Oct. 17-20, 1999, pages W99-1 to W99-4. In this algorithm, spectral values of compressed audio data are scrambled by permutation. Since it is easy to vary the amount of data that is changed (by varying the permutation matrix), different levels of distortion can be achieved. The scrambled audio data still constitutes a standard-compliant MP3 or AAC bit stream, albeit with a degraded playback quality. This allows the listener to identify the musical composition and can motivate the listener to purchase an authorisation key, benefiting the music publisher, the performers, and also the listener.

It is an object of the present invention to provide an alternative scrambling or encryption technique for audio and/or picture data which can have a higher level of security, but where the information content is distorted but recognisable.

According to a first aspect of the invention there is provided a method or apparatus as specified in the claims.

Embodiments of the invention will now be described, by way of example only, with reference to the accompanying schematic drawings, in which:

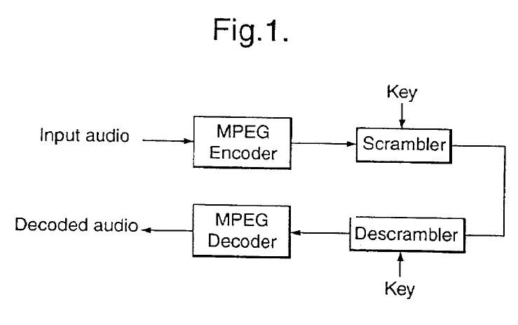

FIG. 1 shows a block diagram of a compression and scrambling cycle,

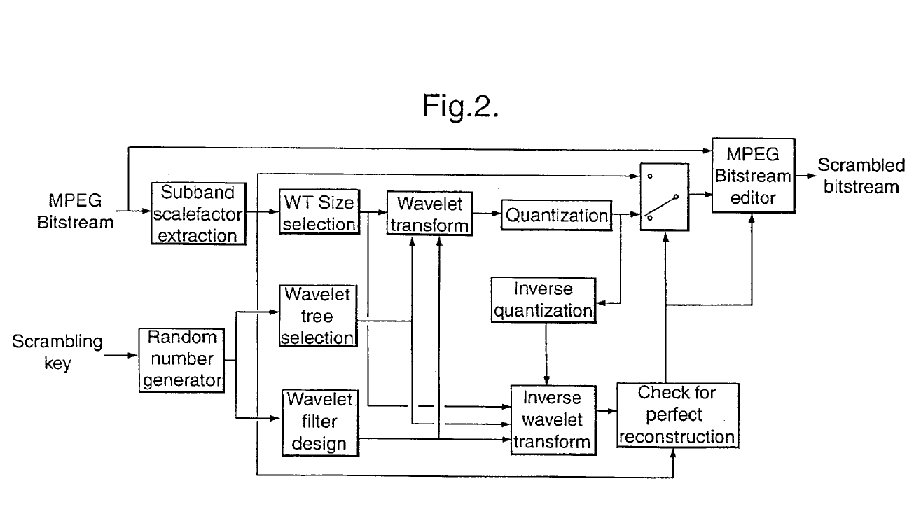

FIG. 2 shows a block diagram of a scrambler according to the invention, and

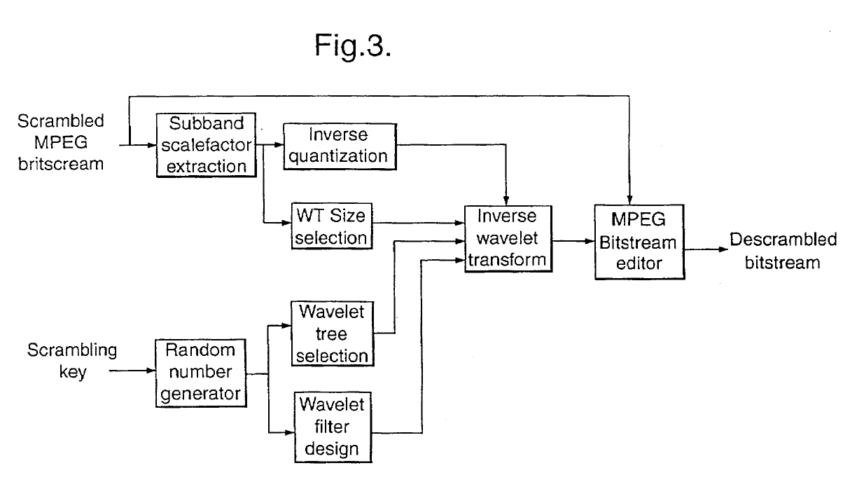

FIG. 3 shows a block diagram of a descrambler according to the invention.

FIG. 4 shows a block diagram of a method according to the invention.

In the following description, the implementation of a wavelet based scrambling system for an MPEG compressed audio bitstream is described. The aim is to scramble the contents of an MPEG audio bitstream using a secret key. The scrambled bitstream will still be MPEG compatible, however the resulting audio quality will be significantly distorted unless it is descrambled with the correct key before it is passed through the MPEG decoder. The encode-scramble-descramble-decode sequence is shown schematically in FIG. 1.

The implementation described here refers to Layer I and Layer II bitstreams. Details of MPEG compression can be found in ISO/IEC JTC1/SC29/WG11 MPEG International Standards ISO/IEC 11172-3, 13818-3, 13818-7, and 14496-3.

The scrambling process is applied to the MPEG compressed bitstream on a frame by frame basis. The most suitable components for scrambling are the sub-band scale factors and/or the spectral coefficients. In the following example scrambling of the scale factors is described, although other components such as the spectral coefficients can be used if desired. An advantage of scrambling the scale factors is that the resulting distortion is spread over all the frequency components of the input signal, and the computational complexity is low due to the small number of scale factors in each frame (up to 32 for Layer I or 96 for Layer II MPEG coders). The number of frames that are actually scrambled for a given audio signal is determined by the requirement to have perfect reconstruction, that is for the scrambling-descrambling process to be transparent resulting in no signal degradation, when the correct keys are used. The algorithm is based on applying a wavelet packet decomposition, as described for example in William H. Press, Saul A. Teukolsky, William T. Vetterling, Brian P. Flannery, “NUMERICAL RECIPES in C: The Art of Scientific Computing”, 2nd Edition, CAMBRIDGE UNIVERSITY PRESS 1992, and A. Akansu and R. Haddad, “Multiresolution Signal Decomposition”, Academic Press, New York, 1993, and Panos E. Kudumakis, “Synthesis and Coding of Audio Signals using Wavelet Transforms for Multimedia Applications”, PhD Thesis, King's Collee University of London, January 1997, to the quantized sub-band scale factors and transmitting with the MPEG bitstream the quantized wavelet coefficients instead of the scale factor values. The security of the system is based on the selection of the wavelet filters and of the decomposition tree. These two features make up the scrambling key, which is needed in order to descramble and obtain the original bitstream.

A block diagram illustrating the main components of the scrambler is shown in FIG. 2. First the MPEG bitstream is parsed on a frame by frame basis in order to extract the quantized scale factor values. In Layer I and Layer II coding each scale factor is quantized with 6 bits, thus the quantizer indexes represent a value in the range 0 . . . . 63. The actual number of scale factors that are contained in the bitstream depends on the output of the bit allocation process.

The size of the Wavelet Transform used in the scrambling process is determined as the largest subset of the existing scale factors that is a power of 2. For the remaining scale factors their original values remain in the bitstream without any further processing. As an example, if we assume that a Layer I coder allocates bits to 19 of the 32 sub-bands of a sample frame, then the bitstream will contain 19 scale factors for that frame. The size of the Wavelet Transform is therefore set to 16, and the remaining 3 scale factors will not be used in the scrambling process (i.e. will not be scrambled).

The security of the system is based on the selection of the Wavelet Filters and of the decomposition tree used in the analysis stage (see for example I. Daubechies, “Ten Lectures on Wavelets”, no. 61 in CBMS-NSF Series in Applied Mathematics, SIAM, Philadelphia, 1992, and A. Akansu and R. Haddad, “Multiresolution Signal Decomposition”, Academic Press, New York, 1993, and Panos E. Kudumakis, “Synthesis and Coding of Audio Signals using Wavelet Transforms for Multimedia Applications”, PhD Thesis, King's College University of London, January 1997.) Without knowledge of these two elements or parameters it is not possible to perfectly reconstruct the original scale factor values during the synthesis stage.

The Wavelet Filters are chosen from a family of 4-tap orthogonal wavelets, whose coefficients {c₀ . . . c₃} are derived from the following relationships (see for example Panos Kudumakis and Mark Sandler, “On the compression obtainable with 4-tap wavelets” IEEE Signal Processing Letters, Vol. 3, No 8, pp. 231-233, August 1996, and Panos Kudumakis, Mark Sandler, Tryfpon Lambrou, Alfred Linney, “On the prediction of 4-tap wavelets coding gain”, TFTS'97, pp. 83-86, Univ. of Warwick, Coventry, UK, Aug. 27-29, 1997:

$$\begin{matrix}{c}_{0} = \frac{1}{2 \sqrt{2}} \div \frac{1}{2} cos θ \\ {c}_{3} = \frac{1}{2 \sqrt{2}} \div \frac{1}{2} sin θ\end{matrix} \} θ ∈ [ 0 , 2 π ]$$

$${c}_{t} = \frac{1}{\sqrt{2}} - {c}_{3} and {c}_{2} = \frac{1}{\sqrt{2}} - {c}_{0}$$

Thus, a choice of an infinite number of 4-tap Wavelet Filters is available which are completely determined by the parameter θ. The values for the parameter θ are chosen using a random number generator that is initialised with the scrambling key. By choosing a new random value of θ for each frame the security of the system is increased as it becomes more difficult for an attacker to approximate the correct analysis filter using trial and error at the synthesis stage. Wavelet Filters having a higher number of taps, such as for example 6-tap filters, may be used as an alternative (see for example Panos Kudumakis and Mark Sandler, “Usage of short wavelets for scalable audio coding”, SPIE'97, Wavelet Applications in Signal and Image Processing V, 3169-21, pp 171-178, San DieO, USA, Jul. 27-Aug. 1, 1997.

A second level of security is added by allowing the decomposition tree to vary randomly on a frame by frame basis. At each step of the wavelet packet decomposition a random decision is taken whether to decompose further a particular sub-band. Thus, any of the possible tree combinations for a given maximum decomposition length can be generated.

In order to preserve the syntax of the bitstream, the wavelet coefficients must be stored using the same number of bits as the original scale factors. Thus, a maximum of 6 bits are available for each wavelet coefficient and any other side information required by the scrambling algorithm.

The wavelet coefficients are quantized with the same scalar quantization algorithm that is used for the spectral values by the MPEG Layer I Encoder. The coefficients of each sub-band are first scaled by the maximum possible value. Then, the scaled WT coefficients are quantized by the function a*x+b where a and b are functions of the number of quantization levels. The result is then truncated to the appropriate number of bits and the MSB is inverted.

The coefficients of the low frequency sub-band are quantized with 6 bits, while the high frequency wavelet coefficients are quantized with 5 or 4 bits. The reason for using a smaller number of bits for the high frequency coefficients is to reserve some bits (one for each scale factor) which will be used to correct the reconstruction errors after the wavelet synthesis stage, wherever possible, as described later.

A requirement for the scrambling system is that when the correct key is used the descrambler is able to perfectly reproduce the original quantized scale factor values. Since the key determines the decomposition tree and the wavelet filters, this means that when the same tree and filters are used to perform the wavelet synthesis it is desired to obtain the original scale factor values.

The reconstruction errors are due to the quantization of the wavelet coefficients. In order to check whether the quantization errors are small enough to allow perfect reconstruction of the scale factors, the inverse quantization and wavelet synthesis are performed inside the scrambler. Thus, the scrambler contains a feedback descrambler. If the reconstruction error is in the range (−1, . . . 1) then it can be corrected by using 1 bit for each scale factor to indicate whether rounding to the higher or lower integer value should be performed by the descrambler in order to obtain the correct value. Thus if Sᵢ and Ŝ are the original and the reconstructed scale factor values then the corresponding error control bit Bᵢ will be calculated as follows:

B₁=1 if −1<S₁−Ŝ₁≦0

B₁=0 if 0<S₁−Ŝ₁<1

If the reconstruction error for at least one scale factor is outside the range (−1, . . . 1) then perfect reconstruction is not possible, the frame is not scrambled and the original scale factor values are inserted in the bitstream. The bits B₁ are combined with the quantized wavelet coefficients and re-inserted in the bitstream. Thus, one flag bit is required for each frame to indicate whether it has been scrambled or not. In the case of stereo signals the scrambling algorithm is applied separately on each channel and so two flag bits are needed. These bits have to be sent to the descrambler e.g. using the IPMP bitstream (see ISO/IEC JTC1/SC29/WG11 MPEG, International Standard ISO/IEC 14496-1, “Coding of Audio-Visual Objects: Systems” and Jack Lacy (AT&T). Neils Rump (FhG), Panos Kudumakis (CRL) “MPEG-4 IPMP Overview & Applications”, publicly available from MPEG or BSI, Ref. as ISO/IEC JTC1/SC29/WG11/N2614 Rome, December 1998) or the auxiliary data as described in ISO/IEC JTC1/SC29/WG11 MPEG, International Standard ISO/IEC 11172-3, “Coding of moving pictures and associated audio for digital storage media at up to about 1.5 Mbit/s”, ISO/IEC JTC1/SC29/WG11 MPEG, International Standard ISO/IEC 13818-3, “Generic Coding of Moving Pictures and Associated Audio: Audio”, and ISO/IEC JTC1I/SC29/WG11 MEG, International Standard ISO/IEC 13818-7, “Generic Coding of Moving Pictures and Associated Audio: Advanced Audio Coding”.

A block diagram showing the main components of the descrambler is shown in FIG. 3. The quantized wavelet coefficients are extracted from the MPEG bitstream. The scrambling key is used to generate the random sequence that drives the filter design and the formation of the wavelet synthesis tree. If the correct key is used then the same wavelet filter pair used during the scrambling process will be generated and the synthesis tree will be equal to the decomposition tree, thus allowing, perfect descrambling of the frame. The error correction bits are used to decide whether to apply upwards or downwards rounding of the Inverse Wavelet Transform output.

An inherent limitation of the scheme is due to the quantization errors of the wavelet coefficients. This has the effect of the scrambling algorithm being applied only to those frames where these errors will not prevent perfect reconstruction, even when the correct keys are used. Also, one or two bits of side information are needed to indicate whether a frame is scrambled or not. Simulations showed that typically around 50% of the frames are actually scrambled. The quantization algorithm has to satisfy the constraint that only 6 bits are available for each coefficient, to preserve the MPEG syntax. Potential improvements could be obtained by using more efficient ways to encode the wavelet coefficients using that limited bit budget.

Another embodiment according to the invention is to apply the scrambling algorithm on the MPEG spectral coefficients. This provides a greater degree of security and better distortion control due to the larger number of coefficients available. On the other hand, the computational complexity of the system may increase.

Although the above description has used an MPEG layer 1 compressed signal, other compression schemes such as, for example, MPEG Layer 3 or AAC schemes (incorporating Huffman coding of the spectral values and/or the scale factors) can be used. If Huffman coded values are present, the number of bits in the scrambled or encrypted frame may be different from that in the original frame. However, since Huffman coding is loss less, the quality is not affected in any way.

Although an embodiment of the invention using Wavelet Filterbank has been described earlier, the scrambling system can also be implemented using any perfect reconstruction filterbank including other wavelet filter types than the 4 and 6-tap aforementioned wavelet filters such as Smith and Barnwell, biorthogonal, etc.

FIG. 4 shows a block diagram of a method according to the present invention. Block 1 denotes encoding of the information content of a compressed bitstream signal to provide a scrambled signal using a wavelet filterbank having a set of parameters, this set consisting of i) an angle which acts as an identifier for the wavelet filter, ii) the nature of the wavelet decomposition tree structure, and iii) the number of stages in the wavelet decomposition tree structure. Block 2 denotes distributing the said scrambled signal to authorised recipients. Block 3 denotes decoding the said scrambled signal to recover the original information content using descrambling means implementing the corresponding inverse wavelet filterbank.

In addition, it is possible to have a scrambling method where the apparent distortion to the original program content increases with time. In other words, the pre-listen feature would not last for ever as the audio or video quality degrades progressively with time. For example, a degradation of 10% could be employed for the first 10 seconds, 40% for the next 10 seconds, 70% for the next 10 seconds and 100% thereafter. Random access to a point in the audio or video signal may also be implemented.

Finally, the priority document GB 0001286.4, especially the drawings, is incorporated herein by reference.

1. A method of scrambling or encrypting a compressed signal to provide a scrambled signal for distribution, the information content being recoverable from the scrambled signal using descrambling means (10) under the control of authorised recipients of the scrambled signal, characterised in that the method consists of or includes:
a) encoding of the information content of a compressed bitstream signal to provide a scrambled signal using a wavelet filterbank having a set of parameters, this set consisting of i) an angle which acts as an identifier for the wavelet filter, ii) the nature of the wavelet decomposition tree structure, and iii) the number of stages in the wavelet decomposition tree structure,
b) distributing the said scrambled signal to authorised recipients, and
c) decoding the said scrambled signal to recover the original information content using descrambling means (10) implementing the corresponding inverse wavelet filterbank.

2. A method as claimed in claim 1, in which the information content comprises audio data and/or picture data.

3. A method as claimed in claim 2, in which the information content in the scrambled signal is distorted but recognisable.

4. A method as claimed in claim 3 in which the apparent distortion to the original program content increases with time.

5. A method as claimed in any preceding claim in which parameters of the filterbank encoding the information content is changed from time to time.

6. A method as claimed in claim 4 in which the time for which a given filter is used is changed from time to time.

7. A method as claimed in claim 4 in which each successive filter appear to have been chosen in a random or pseudo-random fashion.

8. A method as claimed in claim 5 in which the time for which a given filter is used appears to have been chosen in a random or pseudo-random fashion.

9. A method as claimed in any preceding claim in which the decomposition tree structure of the given filterbank is changed from time to time.

10. A method as claimed in claim 8 in which the time for which a given decomposition tree structure is used appears to have been chosen in a random or pseudo-random fashion.

11. A method as claimed in any preceding claim in which the number of stages in the decomposition tree structure of the given filterbank is changed from time to time.

12. A method as claimed in claim 10 in which the time for which the decomposition tree structure having a given number of stages is used appears to have been chosen in a random or pseudo-random fashion.

13. A method as claimed in any preceding claim in which the compressed signal comprises MPEG encoded bitstream data, and the encoding consists of or includes: determining the number of non-zero scale factors or spectral values in each frame of the bitstream data; selecting the scale factors or spectral values to be transformed by the wavelet filterbank; selecting the parameters of a wavelet filter and decomposition tree structure to implement the transformation; performing the transformation using the selected wavelet filter and decomposition tree structure to give a set of wavelet transform coefficients; quantizing these coefficients using a linear quantization scheme; and substituting these quantized wavelet transform coefficients for the original non-zero scale factors or spectral values.

14. A method as claimed in any preceding claim in which the wavelet filterbank is replaced by a perfect reconstruction filterbank.

15. A combination of the aforementioned scrambling method with watermarking.

16. A method of scrambling or encrypting a compressed signal to provide a scrambled signal for distribution, the information content being recoverable from the scrambled signal using descrambling means (10) under the control of authorised recipients of the scrambled signal, characterized in that the apparent distortion to the original program content increases with time.

17. Apparatus for implementing a method of scrambling or encryption as claimed in any preceding claim.
